(19) United States
(12) Patent Application Publication
(10) Pub. No.: US 2014/0273622 A1
(43) Pub. Date: Sep. 18, 2014

(54) High-Temperature RF Connector

(71) Applicant: FCT ELECTRONICS LP, Torringron, CT (US)

(72) Inventors: Kevin John Tagan, Torrington, CT (US); Jason Erik Deren, West Hartford, CT (US)

(73) Assignee: FCT ELECTRONICS LP, Torringron, CT (US)

(21) Appl. No.: 13/833,203

(22) Filed: Mar. 15, 2013

(51) Int. Cl. H01R 9/05

(52) U.S. Cl. CPC H01R 9/0521
USPC 439/584; 439/578

(57) ABSTRACT

An electrical connector includes a substantially cylindrical conducting outer body and coaxial contact portion; the outer body having an opening for receiving an end of a cable; a ceramic annular insulator surrounding the contact portion, thereby electrically isolating the contact portion from the outer body; a connecting body connecting to the outer body and coaxial with the opening; and a ring having an exterior surface in contact with an interior surface of the clamp body and coaxial with the opening. The contact portion includes front and rear portions; the rear portion has a hole therein, substantially coaxial with the opening in the outer body, and a slot intersecting the hole for making a solderless connection to a central conductor of the cable. The ring has a slot therein, the ring thereby being closable to make a solderless connection to an outer conductor of the cable.

### FIELD OF THE DISCLOSURE

This disclosure relates to electrical devices, and more particularly to radio-frequency (RF) connectors suitable for high-temperature environments.

### BACKGROUND OF THE DISCLOSURE

RF cables and connectors are used in a wide variety of applications. RF connectors are typically used with coaxial cables; in an arrangement including cables and RF connectors, the connectors generally offer shielding in accordance with the coaxial design of the cable.

In some situations, for example military applications, coaxial RF connectors must perform in harsh environments. In particular, high-temperature operation may require a solderless connection between the RF connector and the cable.

Accordingly, it is desirable to implement a design for an RF connector suitable for high temperatures, with respect to both its composition and design.

### SUMMARY OF THE DISCLOSURE

According to an aspect of the disclosure, an electrical connector includes a substantially cylindrical conducting outer body, a conducting contact portion coaxial therewith, an annular insulator within the outer body, and an annular interface gasket within the outer body. The insulator surrounds the contact portion and electrically isolates the contact portion from the outer body. The insulator is formed from a material that maintains its form and properties at temperatures above 275° C.; the insulator may be a ceramic or glass. The interface gasket is formed from an elastomer material that maintains its form and properties at temperatures above 275° C. The electrical connector has electrical properties for use at microwave frequencies and provides a solderless connection to a coaxial cable, a printed circuit board and/or a bulkhead. Microwave frequencies are from 100 MHz to 100 GHz.

In an embodiment, the outer body of the connector has an opening for receiving an end of a cable. The connector may also include a conducting contact portion coaxial with the outer body; a ceramic annular insulator within the outer body and surrounding the contact portion, electrically isolating the contact portion from the outer body; a substantially cylindrical connecting body connecting to the outer body and coaxial with the opening; and a ring having an exterior surface in contact with an interior surface of the connecting body and coaxial with the opening. To form a solderless connection to the cable, the contact portion may include front and rear portions, with the rear portion having a hole therein substantially coaxial with the opening and a slot intersecting the hole for making a connection to a central conductor of the cable. The ring has a slot therein and is closable by narrowing the slot; closing the ring makes the solderless connection to an outer conductor of the cable.

In an embodiment, the slot in the rear portion separates a first section and a second section of the rear portion; the hole in the rear portion has a diameter less than that of the central conductor, so that forcing the central conductor into the hole causes the slot to widen and the first section and the second section to resist being spread apart, thereby clamping the central conductor to the contact portion.

In a further embodiment, the annular insulator includes a first ceramic insulator and a second ceramic insulator surrounding the contact portion, and a gasket disposed axially between the first and second insulators; the gasket is formed of an elastomer material. The elastomer material may be specified as rated for use at a temperature of at least 315° C., and for continuous duty at 300° C. The elastomer material may be a perfluoroelastomer.

According to another aspect of the disclosure, an electrical connector includes a substantially cylindrical conducting outer body; a conducting contact portion coaxial with the outer body and including a front portion and a rear portion; and first and second annular insulators disposed within the outer body and surrounding the front portion and the rear portion respectively, thereby electrically isolating the contact portion from the outer body. The first insulator and second insulator are formed from a ceramic or glass material. In an embodiment, the connector is configured for mounting to a bulkhead, and further includes an O-ring for contacting a surface of the bulkhead; the O-ring surrounds the outer body and is formed of an elastomer material. The elastomer material may be specified as rated for use at a temperature of at least 315° C., and for continuous duty at 300° C.; the elastomer material may be a perfluoroelastomer.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a perspective view of a high-temperature RF plug in accordance with an embodiment of the disclosure.

FIG. 2 is a section view of the high-temperature RF plug of FIG. 1.

FIG. 3 shows the high-temperature insulators and gasket used in the RF plug of FIG. 1.

FIG. 4 is an isolated perspective view of a solderless contact in a high-temperature RF connector, in accordance with an embodiment of the disclosure.

FIG. 5 is a section view of the solderless contact of FIG. 4.

FIG. 6 is an isolated perspective view of a clamp ring used to make a solderless connection of a cable to a high-temperature RF connector.

FIG. 7 is a perspective view of a high-temperature RF jack in accordance with an embodiment of the disclosure.

FIG. 8 is a section view of the high-temperature RF jack of FIG. 7.

### DETAILED DESCRIPTION

The embodiments described herein relate to a plug/jack combination of RF connectors. It will be appreciated, however, that the disclosure is not limited to any particular type or design of connector.

FIG. 1 shows a right-angle RF plug in accordance with an embodiment of the disclosure. Plug 100 includes a front body 1 with a coupling nut 2 on the exterior thereof, and a rear body 3 for connecting to a cable (not shown) at a right angle to the front body. The cable is secured to the rear body using clamp body 10 in a solderless connection, described in more detail below. The cable is typically a semi-rigid cable with a central conductor and a coaxial outer conductor.

FIG. 2 is a cross-section view of the RF plug of FIG. 1. Front contact 4 is secured by a press fit to the forward end of contact 5; the rear end of contact 5 has a hole and a slot for receiving the cable conductor. The front body 1 and the rear body 3 each have a recess formed therein, in which is seated an insulator 7. In this embodiment, a gasket 8 separates the two insulators. As shown in FIG. 2, the insulators and gasket each have a central hole on a common axis, for holding contact 5. The electrically conductive components, all but gaskets 6, 8 and insulator 7 are formed from an electrically conductive material. Exemplary is brass, but other suitable materials, such as beryllium copper or stainless steel, may be used.

The insulators 7 and gasket 8 form a three-piece assembly (FIG. 3) of high-temperature dielectric materials. Each insulator 7 may be formed from a ceramic material, or alternatively from a glass material. In this embodiment, each insulator 7 is formed from a ceramic material that is 96%, by weight, aluminum oxide. An exemplary composition, by weight, is 96.01% Al₂O₃, 2.31% SiO₂, 0.69% MgO, 0.69% CaO, 0.07% Fe₂O₃ and the balance alkalis such as K₂O, Na₂O and Li₂).

Gasket 8 serves as a shock absorber; in an embodiment, gasket 8 is formed from an elastomer material (e.g. a perfluoroelastomer) rated for use in high-temperature environments (for example, rated for use at a temperature of at least 315° C., with continuous duty at 300° C.).

Referring back to FIG. 2, plug 100 also has an interface gasket 6 on a forward-facing exterior surface of front body 1. The interface gasket surrounds the forward portion of front body 1 and front contact 4. When RF plug 1 is connected to a jack using coupling nut 2, the proximal end of the jack seats against the forward surface of interface gasket 6. The interface gasket is formed from a high-temperature material such as a perfluoroelastomer.

Contact 5 connects to the central conductor of a cable using a solderless connection. As shown in FIG. 4, contact 5 has a rear portion 51 with a hole 52 therein. Hole 52 is located on the axis of the rear body 3 (see FIG. 2), so that the central conductor of a cable connecting to the plug is aligned with the hole. A slot 53 intersects hole 52 and extends along the axis of rear portion 51; slot 53 splits rear portion 51 into two sections 54, 55 (see FIG. 5). Hole 52 is sized to have a diameter slightly less than that of the conductor. When the conductor is forced into the hole, slot 53 is slightly widened and the two sections 54, 55 are spread slightly apart. Sections 54, 55 resist being spread apart and accordingly close on the conductor, clamping the conductor to the contact 5.

Referring again to FIG. 2, the rear body 3 connects to the outer conductor of the cable using another solderless connection. A connecting body 9, sized to slide over the end portion of the cable, engages with the rear body 3 via a threaded connection. As shown in FIG. 2, ring 10 fits inside connecting body 9 and has a tapered exterior wall meeting the tapered interior wall of connecting body 9. Ring 10 has a slot 61 therein (see FIG. 6), so that the ring is closable by narrowing the slot. When the cable is connected to the plug, the cable is inserted through the ring 10. As the connecting body 9 is threaded onto rear body 3, the tapered profile of connecting body 9 forces ring 10 to close around the outer conductor.

FIG. 7 illustrates an RF jack 70 suitable for use in high-temperature environments, in accordance with another embodiment of the disclosure. Jack 70 is designed as a rear-mount bulkhead connector, for mating with plug 100. As shown in FIG. 8, the jack has a body 71 with external threads, and a central contact 73 with an axial hole 81. When plug 100 is mated with jack 70, coupling nut 2 of the plug makes a threaded connection with jack body 72 while the front contact 4 of the plug engages hole 81 of the jack contact. Annular insulators, including front insulator 72 and rear insulator 74, surround contact 73 and hold the contact in an axial position. In this embodiment, a retaining ring 75 surrounds rear insulator 74 and holds the insulator in place relative to the body 71. Lock washer 77 and nut 78 are disposed about the external threads; when the jack is mounted to a bulkhead (not shown). Nut 78 is tightened against the front surface of the bulkhead while O-ring 76 seats against the rear surface of the bulkhead.

Front insulator 72, rear insulator 74, and O-ring 76 are formed from high-temperature dielectric materials. The front and rear insulators 72, 74 may be formed from a ceramic material, or alternatively from a glass material. In an embodiment, the insulators are formed from a ceramic material that is 96%, by weight, aluminum oxide. O-ring 76 may be formed from an elastomer material (e.g. a perfluoroelastomer) rated for use in high-temperature environments (for example, rated for use at a temperature of at least 315° C., with continuous duty at 300° C.).

While the disclosure has been described in terms of specific embodiments, it is evident in view of the foregoing description that numerous alternatives, modifications and variations will be apparent to those skilled in the art, for example, one or more of the connections may be soldered. Accordingly, the disclosure is intended to encompass all such alternatives, modifications and variations which fall within the scope and spirit of the disclosure and the following claims.

We claim:

1. An electrical connector comprising:
a substantially cylindrical conducting outer body having a central bore extending along a longitudinal axis thereof;
a conducting contact portion disposed within said central bore and longitudinally coaxial with the outer body;
an annular insulator disposed within the outer body and surrounding the contact portion, thereby electrically isolating the contact portion from the outer body,
wherein the insulator is formed from a material that maintains its form and properties at temperatures above 275° C.; and
an annular interface gasket disposed within the outer body,
wherein the interface gasket is formed from an elastomer material that maintains its form and properties at temperatures above 275° C.;
said electrical connector
having electrical properties for use at microwave frequencies; and
providing a connection to at least one of a coaxial cable, a printed circuit board and a bulkhead.

2. An electrical connector according to claim 1, wherein the insulator is formed from a ceramic or a glass suitable for use at temperatures above 275° C.

3. An electrical connector according to claim 1, wherein
the outer body has an opening for receiving an end of a coaxial cable including a central conductor; and
the contact portion includes a front portion and a rear portion, the rear portion having
a hole therein substantially coaxial with said opening and having a diameter less than that of the central conductor, and
a slot intersecting the hole for making a connection to a central conductor of the cable, the slot separating a first section and a second section of the rear portion,
so that forcing the central conductor into said hole causes the slot to widen and the first section and the second section to resist being spread apart, thereby clamping the central conductor to the contact portion to form a solderless connection to the coaxial cable.

4. An electrical connector according to claim 1, wherein the connector provides a solderless connection to a coaxial cable having an outer conductor, the connector including one or more of the following:
(i) the connecting body has a threaded connection to the outer body,
(ii) the connecting body is tapered so that threading the connecting body onto the outer body causes the ring to close on the cable, thereby clamping the outer conductor to the outer body,
(iii) the outer conductor of the cable is welded to the connecting body, thereby electrically connecting the outer conductor of the cable to the connecting body.

5. An electrical connector according to claim 1, wherein the elastomer material is a perfluoroelastomer or other material suitable for use at temperatures above 275° C.

6. An electrical connector according to claim 1, wherein the connector is configured for mounting to a bulkhead, and further comprising an O-ring for contacting a surface of the bulkhead, the O-ring surrounding the outer body and formed of an elastomer material.

7. An electrical connector comprising:
a substantially cylindrical conducting outer body, the outer body having an opening for receiving an end of a cable;
a conducting contact portion coaxial with the outer body, the contact portion including a front portion and a rear portion;
an annular insulator disposed within the outer body and surrounding the contact portion, thereby electrically isolating the contact portion from the outer body;
a substantially cylindrical connecting body connecting to the outer body and coaxial with said opening; and
a ring interior to the connecting body and coaxial with said opening,
wherein
said insulator is formed from a ceramic or glass material,
the rear portion has a hole therein substantially coaxial with said opening and a slot intersecting the hole for making a connection to a central conductor of the cable, and
the ring has a slot therein, the ring being closable by narrowing said slot to make a connection to an outer conductor of the cable.

8. An electrical connector according to claim 7, wherein said insulator is formed from a ceramic material.

9. An electrical connector according to claim 7, wherein
the slot in the rear portion separates a first section and a second section of the rear portion, and
the hole in the rear portion has a diameter less than that of the central conductor,
so that forcing the central conductor into said hole causes the slot to widen and the first section and the second section to resist being spread apart, thereby clamping the central conductor to the contact portion.

10. An electrical connector according to claim 7, wherein
the connecting body has a threaded connection to the outer body, and
the connecting body is tapered so that threading the connecting body onto the outer body causes the ring to close on the cable, thereby clamping the outer conductor to the outer body.

11. An electrical connector according to claim 7, wherein the annular insulator includes
a first ceramic insulator surrounding the contact portion,
a second ceramic insulator surrounding the contact portion, and a gasket disposed axially between the first ceramic insulator and the second ceramic insulator, the gasket being formed of an elastomer material.

12. An electrical connector according to claim 11, wherein the elastomer material is rated for use at a temperature of at least 315° C., and for continuous duty at 300° C.

13. An electrical connector according to claim 11, wherein the elastomer material is a perfluoroelastomer.

14. An electrical connector according to claim 7, further comprising an annular interface gasket coaxial with said annular insulator and disposed on a face of the outer body radially separated from said front portion of said contact portion, the interface gasket being formed of an elastomer material.

15. An electrical connector according to claim 14, wherein the elastomer material is rated for use at a temperature of at least 315° C., and for continuous duty at 300° C.

16. An electrical connector according to claim 7, wherein the connector is configured to provide a solderless connection to at least one of the central conductor and the outer conductor of the cable.

17. An electrical connector comprising:
a substantially cylindrical conducting outer body;
a conducting contact portion coaxial with the outer body, the contact portion including a front portion and a rear portion;
a first annular insulator and a second annular insulator disposed within the outer body and surrounding the front portion and the rear portion respectively, thereby electrically isolating the contact portion from the outer body,
wherein the first insulator and second insulator are formed from a ceramic or glass material.

18. An electrical connector according to claim 17, wherein the first insulator and the second insulator are both formed of a ceramic material.

19. An electrical connector according to claim 17, wherein the connector is configured for mounting to a bulkhead, and further comprising an O-ring for contacting a surface of the bulkhead, the O-ring surrounding the outer body and formed of an elastomer material.

20. An electrical connector according to claim 19, wherein the elastomer material is rated for use at a temperature of at least 315° C., and for continuous duty at 300° C.
